(19) United States
(12) Patent Application Publication
(10) Pub. No.: US 2002/0116272 A1
(43) Pub. Date: Aug. 22, 2002

(54) Advertising strategy and motivational behavior modification method for weight loss

(76) Inventor: Alexander Goen Szynalski, Randolph, NJ (US)

Correspondence Address: PHARMACEUTICAL PATENT ATTORNEYS, POHL & ASSOC. LLC, 55 MADISON AVENUE, 4TH FLOOR (P4014), MORRISTOWN, NJ, 07960-6397, US

(21) Appl. No.: 10/131,868

(22) Filed: Apr. 25, 2002

Related U.S. Application Data
(63) Continuation-in-part of application No. 09/427,447, filed on Oct. 27, 1999.

(51) Int. Cl. G06F 17/60

(52) U.S. Cl. 705/14

(57) ABSTRACT

A weight control system combining a weight control substance with a live beauty pageant; the weight control substance addresses physical parameters affecting weight control, while the beauty contest addresses psychological parameters affecting performance optimization.

### CROSS REFERENCE

This application is a continuation in part of serial No.09/427,447 (filed Oct. 27, 1999), now U.S. Pat. No.______.

### GOVERNMENT RIGHTS

None.

### BACKGROUND

A portion of this disclosure of this patent document contains material which is subject of copyright protection. The copyright owner has no objection to the facsimile reproduction by anyone of the patent disclosure, as it appears in the Patent and Trademark Office files or records, but otherwise reserves all copyright rights whatsoever.

This application relates to an improved method for advertising weight-loss dietary supplements. The method improves not only the effectiveness of the advertising, but also improves the probability the consumer will achieve a successful outcome in their weight loss program.

In the parent patent application, I discuss behavior modification technology, and disclose how to make a behavior modification program most effective to improve a wide variety of behaviors. For one specific behavior pattern—overeating—I have found that a person seeking to lose weight can be hampered from achieving their weightcontrol goals by several factors endemic to our society.

First, overeating is endemic to contemporary American society. Thus, changing over-eating behavior requires not just altering personal behavioral habits, but altering them to, in some regards, violate prevailing social norms. These social norms, while I, unhealthy, pose an extremely strong emotional obstacle to maintaining healthy eating behavior.

Second, because over-eating is endemic, it is seductively easy for a person seeking to lose weight, to decide to begin to lose weight “tomorrow.” Without some fixed, emotionally-charged time deadline, even the most well-intentioned person may postpone or interrupt their weight control program for various reasons, ranging from holidays and vacations to stresses such as sickness or employment problems.

Third, the pervasiveness of obesity makes it difficult for a person seeking to lose weight to accurately measure, on an intuitive level, whether they are in fact overweight and how severe the problem may be. Thus, while the art is replete with books on how to lose weight, reading a book alone often fails to achieve the desired result, as simply reading a book does little to demonstrate to the person their own current state of obesity.

### SUMMARY

I have found a way to address all of these problems, by collecting a variety of previously-known elements into a new combination. I have found a way to maximize the participant's likelihood of achieving their weight-control goals, by providing an emotionally-charged motivational schema, to enable a person to resource the emotional strength necessary to resist the prevailing societal habit to over-eat. I provide this motivational schema tied to a pre-defined timeline, with an emotionally-charged finish, to assure a level of time-responsiveness in the person's response. I do this all using multimedia technology, to assure technology is used most fully to motivate the person to achieve their weight loss goals.

My system involves providing a weight control program that includes (1) a weight loss substance, to address the person's physical urges to eat; (2) a program of education for the conscious mind, to address the person's understanding of the health risks of over-eating and the benefits of good diet; and (3) a behavior modification program which includes a beauty contest and, if desired, hypnosis. The beauty contest is extraordinarily important as a vehicle to both clearly show the person their current potential to achieve weight control, and to establish a fixed, time-sensitive deadline for the person to achieve their weight control goals.

### THE DRAWINGS

FIG. 1 provides an overview of the process.

FIG. 2 provides a series of photographs disclosing evidence of the clinical results and efficacy of my system.

### DETAILED DESCRIPTION

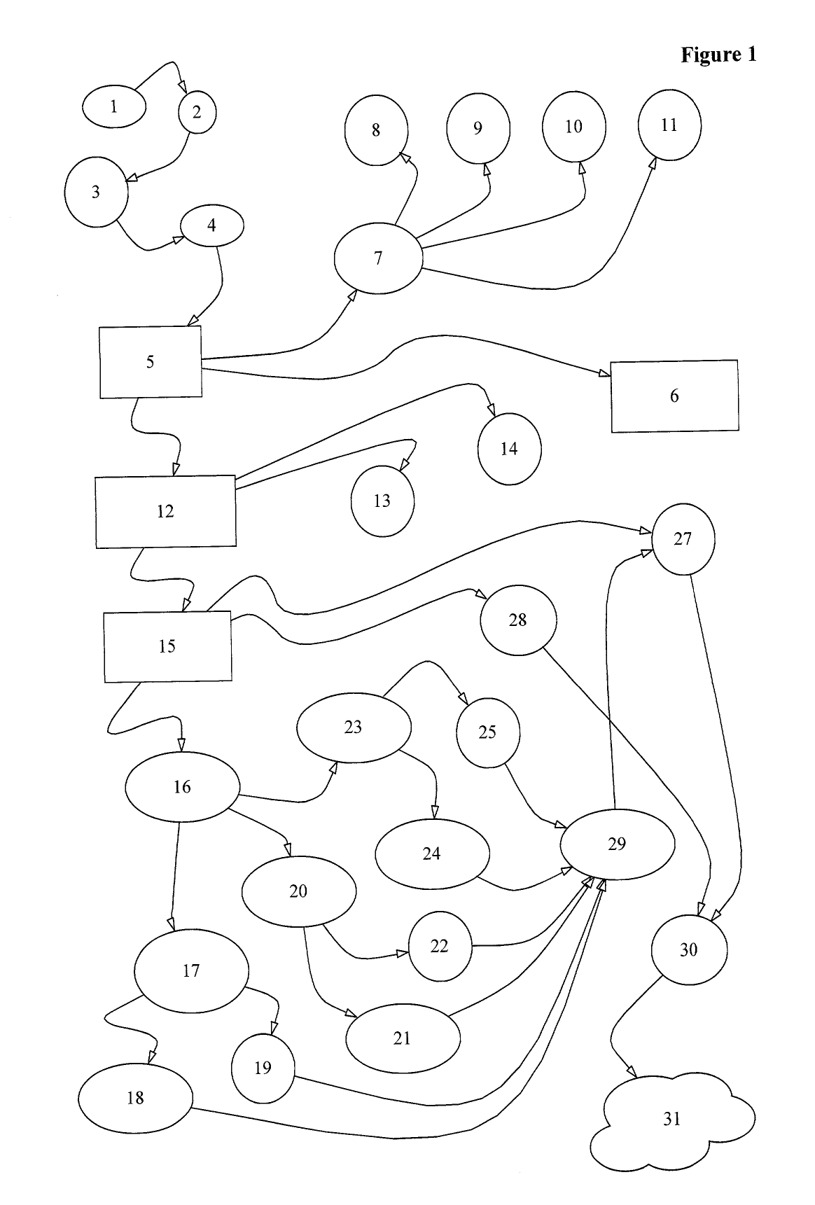

I will begin to discuss my currently-preferred version of my invention by referring to the enclosed Figure 1.

Advertising

The process starts by reaching out to consumers—potential patients or clients who would like to achieve or maintain a healthy body weight. Such outreach can be done by publishing news releases, web-sites, magazine articles or books, doing interviews, or purchasing internet or other advertising media resources.

Optimally, the outreach program is prefaced by some amount of market research [1] . Market research is useful to identify people most likely to need or want a weight control program, and identify the likely venues to reach these people. By doing preliminary market research, the system operator has greater assurance that the subsequent consumer outreach phase balances a thorough targeting of the target audience, with an economical avoidance of expending resources on peripheral, nontarget audiences.

Once the market research [1] has identified likely target markets and media, a consumer outreach program [2] is pursued. The consumer outreach program is optimally designed to both generate sales leads [3] and close sales [4] for consumers interested in participating in the system.

Once a consumer accepts participating, the consumer begins participating in the weight loss program [5]. The weight loss program [5] preferably consists of three components: an educational component [6], a weight loss substance [7] and a sub-conscious intervention component [12].

The Educational Component

The educational component [6] is for the conscious mind regarding body weight, the physiological dangers of being overweight, and techniques to maintain a healthy body weight. The physiological dangers of being overweight are now so widely known as to not need to be discussed in detail here. The educational component can include addressing the benefits of a regular exercise program, diet training, diet measurement approaches and other aspects of weight control. Thus, the educational component can educate the consumer regarding the benefits of engaging in some form of light exercise. Not only will light exercise help clear the body of toxins, but exercise will also help release endorphins which relieve stress as well as making you feel good. This helps to address one of the psychological aspects of being overweight—overeating behavior as compensation for emotional issues such as depression, loneliness or the like. If the consumer has not engaged in exercise for a long time, or is more than mildly overweight, or has any other health problem, they should consult their physician before starting an exercise regime.

In addition to this, in my preferred embodiment, the education component also addresses the physiological progression of eating and digestion (e.g., the digestive process and its impact on blood sugar levels), as well as some conscious techniques to measure and control eating. In my preferred embodiment, the consumer is educated on the benefits of modifying their daily diet.

I recommend the following: Avoid refined carbohydrates. All carbohydrates start out in their rarest edible form as complex, but e make them refined by processing, preserving, storing, drying and cooking. Increase physical activity, especially five to fifteen minutes after meals. Eat healthy, nourishing, non-processed foods and take a good vitamin supplement. Have protein and complex carbohydrates with each meal. Avoid sugar. Drink 8 glasses of non-caloric liquids a day (e.g., water with lemon, seltzer, herbal tea, etc. . . ). Keep a pitcher of water on your desk, and you'll easily drink 8 glasses a day. Between meals, drink fruit juices or eat a piece of fruit. Eat lots of fruit, vegetables and salads. As soon as you finish eating, leave the table and go brush your teeth. Use mouthwash whenever possible. Do not skip any meals, and never miss breakfast. Limit refined sugar intake, and read packaging labels. Avoid all alcohol. I discuss other diet education tips and suggestions in the parent patent application.

The Weight Loss Substance

In addition to the educational component [6], I prefer to include a weight loss substance [7]. The weight loss substance [7] can be one or more of a variety of substances, known for their efficacy in promoting healthy body weight or reducing overweight. The weigh loss substance [7] may be a prescription pharmaceutical [8]. Examples of a prescription weight loss substance [8] include the prescription anorexics aminorex, amphetamine, chlorphentermine, clortermine, cyclexedrine, diethylproprion, fenfluramine, phentermine and others.

The weight loss substance may alternatively be a non-prescription or “over-the-counter” weight loss or stimulant drug [9]. Examples known in the art include No-DOZE® caffeine pills and the like. Stimulants such as caffeine are known to both increase the user's metabolic rate (increasing the amount of calories used) and suppress the appetite (decreasing the user's total caloric intake).

The weight loss substance may alternatively be a dietary supplement [10]. Various dietary supplements are known to be helpful in weight control. These include both stimulants and compounds such as B-vitamins or chromium. For example, I recommend that consumers take 100 micrograms of chromium (along with the proper co-factors) one half hour before each meal, with a full glass of water.

Sub-Conscious Intervention

In addition to the weight loss substance, I prefer the weight loss program [5] include a sub-conscious intervention component [12]. The sub-conscious intervention component may be provided to the consumer on a cost-effective basis as a group seminar [13]. Such a seminar may effectively present both the education component [6] and the sub-conscious intervention component [12] together in a unified fashion, in a seminar format.

Alternatively, the sub-conscious intervention component [12] may include individual counseling or hypnotherapy [14]. Individual counseling [14] is perhaps more expensive to administer to the consumer than group seminars [13], albeit may provide more effective intervention than group-based therapy [13]. Individual counseling [14] may be provided as in-person intervention, but may be provided as at at-home program (e.g., as per a cassette tape program or videotapes) in addition to ir in lieu of in-person intervention. Whether individual or group, the basic techniques of sub-conscious intervention, and the rationale for using it, are discussed fully in the parent patent application and its prosecution history, incorporated here by reference.

The Beauty Contest

Whether or not seminars [13] or individual counseling [14] are used, it is essential for my invention that a motivational beauty contest [15] is used. The motivational beauty contest [15] is designed to address several cognitive goals. First, the beauty contest is designed to provide an emotionally-evocative, compelling presentation to the consumer, presenting the consumer's current weight status over a period of time. This could conceivably be done by a number of techniques.

Multi-Media Progress Survey

For example, the consumer can weigh themselves on a bathroom scale and keep a chart of their weight over time. This approach I believe less effective, because a chart of scientific data, while it may appeal to the consumer's conscious, logical mind, will have little emotional cogency, thus little effect as an agent of intervention on the sub-conscious mind.

Similarly, it is conceivable to take before- and after- photographs of the consumer. Such photographs illustrate the consumer's status in a somewhat more emotionally powerful fashion than a dispassionate chart of body weight. Mere photographs, however, provide only a limited improvement in emotional impact. I prefer more—much more—as the strength of the emotional impact on the consumer is synergistically related to the effectiveness of the weight loss program [5] as a whole.

To appeal most strongly to the user's sub-conscious mind—to provide the strongest agent of sub-conscious intervention—I require using a more emotionally evocative type of presentation. I have found a way to achieve this goal, in the age-old format of a live beauty contest.

While not required, the live beauty contest may be prefaced by a multi-media record [15] of the contestants'progress leading up to the beauty pageant. Multi-media technology makes this superior approach available for the first time, and is synergistically effective for the effectiveness of my system. Thus, the multi-media record [15] uses a multi-media survey [16], an audio-visual (e.g., a digital video movie) survey of the consumer over time.

The multi-media survey must show the consumer's progress over time. Thus, the multi-media survey [16] includes a “before” survey [17], an in-progress survey [20] and an “after” survey [23]. Each survey shows the consumer at the relevant time period. The before survey [17] thus optimally shows the consumer before they begin participating in the educational program [6] or taking a weight loss substance [7] or pursuing seminar [13] or individual counseling [14]. I require the before survey [17] to include an audio-visual part [18], comprising a movie of the consumer before they begin the weight loss program. This part is most effective to the extent it shows the consumer's present body state; a home movie of the consumer in a bathing suit works well for this purpose.

I prefer (but do not require) the before survey also include what I call an “editorial” portion [19]. The editorial portion [19] is an interview with or monolog by the consumer, wherein the consumer articulates and memorializes their own goals and aspirations for the weight loss program. By articulating their goals on videotape, the consumer makes an emotionally cogent presentation for themselves, a presentation more effective than the consumer simply writing out a “mission statement” or essay.

The in-progress survey [20] includes an audio-visual component [21], optionally in combination with an editorial component [22]. The audio-visual component [21] shows the consumer at one or more times during their participation in the weight loss program [5]. This enables the consumer to apprehend their progress in the program dramatically, in a manner so emotionally cogent that it can impact the consumer's subconscious mind most effectively. The optional in-progress editorial component [22] allows the consumer to articulate their own opinion of and feelings regarding their progress on videotape, to create a similarly emotionally-charged archive of the process, to further motivate the consumer.

The after survey [23] includes an audio-visual component [24], optionally in combination with an editorial component [25]. The audio-visual component [24] shows the consumer at the completion of their participation in a particular phase of the weight loss program [5]. This enables the consumer to apprehend their total to-date progress in the program dramatically, in a manner so emotionally cogent that it can impact the consumer's subconscious mind most effectively. The optional after editorial component [25] allows the consumer to articulate their own opinion of and feelings regarding their total progress and success on videotape, to create a similarly emotionally-charged archive of their achievement, to further motivate the consumer in the future, to continue to pursue a healthy lifestyle even after they stop participating in the weight loss program [5].

The audio-visual components [18] [21] [24] are essential to the function of the surveys [17] [20] [23]. The editorial components [19] [22] [25] are preferred, but not essential for the operation of my system.

The Pageant A problem many people have in pursuing a weight loss program is the tendency we all have to delay or postpone what we anticipate will be difficult or painful tasks. One such task is a weight loss program. The way I eliminate or address this psychological barrier, is to put a fixed time period on the weight loss program [5], by providing the beauty contest [15] with certain required elements.

One essential element is a scheduled beauty pageant time or “deadline” [28]—a fixed time the beauty pageant [30] will take place, and the consumer's results judged. The deadline [28] is essential, as it strikes to the core of one of the most difficult problems in weight loss practice - our tendency to delay or postpone the work involved in achieving personal goals such as weight loss. By providing a beauty contest deadline [28], the consumer's tendency to postpone or delay is minimized.

Another beauty contest element is a beauty contest goal or criterion [27]. The criterion [27] may be precise and quantitative (e.g., ratio of body measurements, maximum percent of non-water body weight lost per week; shortest time to achieve healthy body weight for all consumers of a given certain percentage overweight at the start of the beauty contest period). Alternatively, the criterion [27] may be more vague and qualitative (e.g., best appearance in a bathing suit or evening wear; most satisfied with weight control results). In whatever form, the criterion must, simply, provide a goal or target for the consumer to aim for, in their participation in the weight loss program [5]. I prefer to use a subjective criterion, because quantitative criteria are often more powerful as motivators for the conscious mind, while subjective criteria are often more powerful as an instrument of sub-conscious motivation.

The beauty contest may use as input for the criterion [27] the actual performance data [29] of the consumer. This actual performance data includes at least the after survey [23] audio-visual component [24] (to assess end results) and, preferably, the before survey [17] audio-visual component [18] (to assess beginning state and progress). It is preferable to include the before survey [17] audio-visual component [18], because the effectiveness of the beauty contest [15] as a tool for sub-conscious intervention requires the consumer—during the progress of the weight control program [5]—to view the beauty contest as a goal-achievement contest, rather than simply a beauty pageant. Put differently, for the beauty contest to function as a sub-conscious motivational tool, it is important for consumers participating in the weight loss program [5] to not only see the contestants and winners of past beauty pageants, but to apprehend that some of them were in fact, just like the consumer before beginning the weight control program. Thus, it is preferable to include before survey [17] data in the actual performance data [29], to assure that the actual performance data [29] measures not good looks in the abstract, but change and improvement over the course of the weight loss program [5].

The beauty contest [15] may use the actual performance data [29] as variable input to be assessed against the beauty contest criterion [27], as the basis for an evaluation or judging of contestants is done, to select a winner or winners.

The Beauty Pageant

The beauty contest [15] finishes with the hosting of a live beauty pageant [30]. The live beauty pageant [30] is important, albeit not necessarily for the accuracy or precision of the evaluation of any given contestant's progress. The real value of the pageant [30] is that it provides the contestant, during their participation in the weight loss program [5], something to look forward to and aim for. Thus, I prefer the pageant [30] be structured to provide another emotionally-charged tool able to affect the contestant's sub-conscious, to maximize their motivation to pursue the weight loss program [5]. Thus, the pageant must be an in-person beauty pageant. Thus, while the pageant may be videotaped for later broadcast, the pageant itself must be held with groups of contestants appearing live in a central location or locations for show and judging. It is possible to have the pageant at more than one location; for example, one can hold a local area beauty pageant in Cincinnati, Ohio, another local pageant in Belmar, N.J., and a third in New York City, N.Y., perhaps linked by simulcast broadcasting. It is essential, however, that each pageant site have a number of contestants there at the same time, creating a group atmosphere. By creating such a group atmosphere, the pageant generates a sense of excitement for the participants, much more so than if the participants simply mailed in before- and after- photographs to an evaluation committee, and waited for results to be selected.

The beauty pageant should have a winner or winners, judged according to some criterion. There are a plethora of ways to compare beauty. Photographs may be submitted, for example, as is done by casting agencies for models and actresses. Similarly, video presentations may be used, to display the model's appearance when moving. Alternatively, an evaluation could be done by way of an in-person videotaped interview of the model. With such an interview, however, the model still is, at the end of the day, interviewed alone. Such media-based (rather than in-person) comparison provides a mechanism for a judge to evaluate and compare various models. It fails, however, to provide a tool to sub-consciously motivate the models themselves to pursue optimal performance, because these mechanisms all rely on the model being relatively isolated or solitary during the process.

I have found that by providing the model comparison in a group setting, rather than a solitary setting, the beauty contest [15] becomes not only an amusing diversion or adventure, but also a powerful tool for sub-conscious motivation, encouraging the model to achieve optimal performance during the course of the weight loss program [15]. Thus, I require that the beauty contest [15] end with a beauty pageant [30] where the contestants arrive at one or more physical locations on a given date [28] to be evaluated and judged in a group setting. Beauty pageants are known, albeit not apparently known in the art of weight control, nor as a tool for sub-conscious motivation. Beauty pageants typically start with some type of ceremony, and then proceed to introducing the contestants, and then to the judging of the various contestants according to one or more criteria [27]. The pageant may use as criterion [27] the contestants'present state (that is to say, at the time of the pageant), or the contestants'change or improvement in state over the course of the weight control program [15] (that is to say, looking not only at the contestants'health at the time of the pageant, but also their health in the past, when they started participating in the weight control program [15]).

Because it is so important to the effectiveness of my invention, I use the term “pageant” in the appended claims to mean an evaluation of a plurality of contestants at a the same location, at the same time, where the contestants must appear in-person for judging. Thus, by definition, the term “pageant” excludes (i) evaluation of only one contestant (e.g., solitary evaluation against some pre-determined criterion); (ii) evaluation of a plurality of contestants where the contestants need not appear at the same place at the same time (e.g., if the contestants simply mail in their photographs or videotapes, for later comparison and judging).

The beauty contest [15] ends with an award [31] to one or more winners. The award need not be particularly valuable—the true reward for the contestant is their loss of weight and achieving a healthier lifestyle. Thus, while one could conceivably offer a new sports car as an award, it is sufficient for the effectiveness of the system to simply offer recognition as the winner, without any personal property being given at all. Such an award of public recognition can be as sub-consciously motivational as a more monetarily-valuable award of personal property. It is most important that the award, whether of personal property or simply a recognition of “winner” status, be emotionally evocative. For example, the award could be presented in an emotionally-evocative setting. The award thus functions not only as an award of good work done, but also as an effective tool for sub-conscious and conscious intervention to motivate the contestants to try to do their best.

The efficacy of my system can be observed in FIG. 2. FIG. 2 discloses photographs of what may be considered “experimental data,” data relating to actual contestants who have completed my system. FIG. 2 thus provides evidence that my system in fact works—and works extremely well—for its intended purpose.

SYNOPSIS

While I discuss various examples of my system here, I use these as examples only, and modifications will become familiar to those of skill in the art. Thus, I intend this patent to cover the system as encompassed by the claims appended here and their equivalents.

Note that throughout this patent and the appended claims, I use the singular to allow for one or more of the object referred to. The term “pageant” is defined in the Specification. The term “purchase” means not only a direct purchase, but any indirect or equivalent purchase (e.g., by rebate, free give-away in return for a coupon or purchase of another good or service).

I claim:

1. In a method of marketing a weight control substance to a consumer, the improvement comprising advertising participation in a beauty pageant, said pageant comprising an evaluation of said consumer against a plurality of other beauty pageant contestants, said consumer and said other contestants appearing in-person for judging at a beauty pageant location.

2. The method of claim 1, wherein said consumer can participate in said beauty pageant only if said consumer purchases said weight control substance.

3. A method comprising:
a. Offering to a consumer a weight loss substance, and
b. Offering to said consumer the opportunity to participate in a beauty pageant.

4. The method of claim 3, wherein said opportunity to participate in said beauty pageant is contingent on said consumer purchasing said weight loss substance.

5. A weight loss method comprising:
a. providing to a consumer a weight loss substance in an amount effective to control weight; and
b. providing to said consumer a beauty pageant comprising an evaluation of said consumer against a plurality of other contestants, said consumer and said contestants appearing in-person for judging at a beauty pageant location.

6. The method of claim 5, further comprising:
c. preparing a multi-media before survey and a multi-media after survey.

7. The method of claim 6, further comprising:
d. preparing a multi-media in-process survey.

8. The method of claim 6, said multi-media after survey comprising an audio-visual part and an editorial portion.

9. The method of claim 5, further comprising:
c. providing to said contestant an educational component for the conscious mind.

10. A weight loss system comprising:
a. a weight loss substance in an amount effective to control weight; and
b. a beauty pageant comprising an evaluation of a consumer against a plurality of other contestants, said consumer and said other contestants appearing in-person for judging at a beauty pageant location.

11. The system of claim 10, further comprising:
c. a multi-media before survey and a multi-media after survey.

12. The system of claim 11, further comprising:
d. a multi-media in-process survey.

13. The system of claim 12, said multi-media after survey comprising an audio-visual part and an editorial portion.

14. The system of claim 10, further comprising:
c. an educational component for the conscious mind.
